(19) United States
(12) Patent Application Publication
(10) Pub. No.: US 2018/0237223 A1
(43) Pub. Date: Aug. 23, 2018

(54) Pile Underground Fluid Storage Assembly

(71) Applicants: David R. Hall, Provo, UT (US); Seth Myer, Eagle Mtn., UT (US)

(72) Inventors: David R. Hall, Provo, UT (US); Seth Myer, Eagle Mtn., UT (US)

(21) Appl. No.: 15/438,125

(22) Filed: Feb. 21, 2017

(51) Int. Cl. B65G 5/00; E02D 5/22; B65D 88/76; B65D 88/54; B65D 88/02; B65D 88/74; B65D 90/48; B65D 90/12; B65D 90/10

(52) U.S. Cl. CPC B65G 5/00; E02D 5/22; B65D 88/76; B65D 88/54; B65D 88/022; E02D 7/02; B65D 90/48; B65D 90/12; B65D 90/10; E02D 2200/1685; B65D 88/74

(57) ABSTRACT

A pile underground fluid storage assembly is disclosed which allows the labor of installing two systems to be shared, therefore reducing installation costs. The assembly includes a foundation pile for structural support of the building structure along with storage tanks for storage of fluids at various temperatures as required for building operations, with the tanks being located within the interior space of the pile. The assembly further reduces maintenance and repair costs by making the underground tanks accessible. It also prevents underground storage tank floating issues when groundwater levels exceed storage tank fluid levels.

### BACKGROUND

### Field of the Invention

This invention relates to the use of piles for storage of fluids in underground storage tanks within the interior space of the piles.

### Background of the Invention

Storing fluids for use in systems and processes is normally done in some type of containment system such as in a tank or enclosure. The container is often insulated in order to maintain the temperature of the fluid within a specified range. Typically, each storage tank or enclosure contains fluid that is maintained within a range of temperatures specific to a specific use or application. For secondary applications that require fluids of higher temperatures than those of a first storage tank, a second tank may be provided that maintains these higher temperatures.

In some applications, these storage tanks are buried in the ground. Underground tanks have several advantages over above ground tanks. Above ground tanks are unsightly or obstructive, there may not be an appropriate site for the installation of an above ground tank on a property. Also, there are security issues with above ground tanks since they are easily accessible. In addition, the outside temperature influences the temperature of the fluid being stored inside the tank, even if the tank is insulated.

The advantages of underground storage tanks are known, however there are also some disadvantages associated with underground tanks. One of the main considerations is cost. Underground tanks can be up to 3 times more expensive than above ground tanks when including the material costs and installation costs. There are also maintenance issues since the tank is underground and not easily accessible. In some cases an underground tank would have to be dug up in order to repair or replace it. There are also floating issues in the case of surrounding groundwater levels being higher than the fluid levels within the tank. The floating force can potentially cause the tank to float up or push out of the ground.

An underground fluid storage system is needed that includes all of the advantages, and at the same time addresses the disadvantages listed above. In addition, an underground storage system with multiple fluid tank assemblies for more than one fluid type or temperature of fluids is needed.

### SUMMARY

This invention has been developed in response to the present state of the art and, in particular, in response to the problems and needs in the art that have not yet been fully solved by currently available systems and methods. Features and advantages of different embodiments of the invention will become more fully apparent from the following description and appended claims, or may be learned by practice of the invention as set forth hereinafter.

Consistent with the foregoing, a pile underground fluid storage assembly is disclosed which allows the labor of installing two systems to be shared, therefore reducing installation costs. The assembly includes a foundation pile for structural support of the building structure along with storage tanks for storage of fluids as required for building operations located within the interior space of the pile. The assembly further reduces maintenance and repair costs by making the underground tank accessible. It also prevents underground storage tank floating issues when groundwater levels exceed storage tank fluid levels.

In one embodiment, the pile underground fluid storage assembly includes a storage pile assembly, including: an at least partially hollow cylindrical foundation pile comprising a longitudinal central axis; one or more fluid tank assemblies concentric with the central axis disposed inside the foundation pile; piping for supply and return of fluids to the one or more tank assemblies; and wherein the foundation pile is driven into the ground and the tank assemblies reside within a section of the foundation pile that is at least two to twenty meters below ground level.

The one or more fluid tank assemblies in certain embodiments includes a tank within a tank as follows: a first tank which has a second tank inside the first tank, and where there is further a third tank inside the second tank. Each of these three tanks have a storage capacity that allows the storage of fluids within each of these tanks.

In an embodiment, the fluid stored inside the one or more fluid tank assemblies is either a liquid or a gas. In another embodiment, the fluid stored inside the one or more fluid tank assemblies is either pressurized or non-pressurized.

In certain embodiments, the one or more volumes of fluid stored inside the one or more fluid tank assemblies of the one or more fluid tank assemblies are of different temperatures. In another embodiment, the temperature of the first volume of fluid is at a lower temperature than the second volume of fluid; and the second volume of fluid is at a lower temperature than the third volume of fluid.

In other embodiments, one or more surfaces of the one or more fluid tank assemblies are thermally insulated. In another embodiment, each individual tank of the one or more fluid tank assemblies further comprise an inlet pipe for supplying fluid, and an outlet pipe for fluid flowing out. In an embodiment, the inlet pipe extends to a location near a bottom of the individual tank, and the outlet pipe is at a location near a top of the individual tank.

In certain embodiments, heating elements within each of the one or more fluid tank assemblies for heating fluid contained within each of the one or more fluid tank assemblies, the heating elements including components from the group of: electric heat tape, electric heat trace, heat exchangers, heating pipes, and heat exchange mechanisms.

In an embodiment, sensors from the group of: temperature sensors, pressure sensors, and flow sensors for monitoring conditions within each section of the one or more fluid tank assemblies.

In one embodiment, a shape of each storage section is configured to minimize heat transfer between the one or more fluid tank assemblies. In another embodiment, a shape of each storage section is configured to maximize heat transfer between the one or more fluid tank assemblies.

In an embodiment, each of the one or more fluid tank assemblies is a storage tank. In another embodiment, the one or more fluid tank assemblies is removeable from the pile for maintenance or replacement.

In certain embodiments, the storage pile assembly includes insulation inside a top section of the pile above the one or more fluid tank assemblies. In another embodiment, a top of the pile is capped, sealing an interior of the pile and the one or more fluid tank assemblies from outdoor elements from the group of: water, dirt, insects and all other elements that may degrade or damage the one or more fluid tank assemblies. In other embodiments, the inlet pipes and the outlet pipes are insulated.

In an embodiment, the storage pile assembly includes a structural support plate at the top of the pile for support of a building or structure; and wherein the support plate includes an opening for inlet and outlet pipes to extend from the interior of the pile to systems outside of the pile.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a cross section view of a storage pile assembly driven into the ground, according to one example embodiment.

FIG. 2 is an isometric view of one embodiment of a one or more fluid tank assemblies showing three cylindrical tanks within the one or more fluid tank assemblies, according to one example embodiment.

FIG. 3 is a cross section view of the one or more fluid tank assemblies showing fluids of varying temperatures inside each of three storage tanks, according to one example embodiment.

FIG. 4 is a cross section view of the storage pile assembly showing piping entering the assembly, according to one example embodiment.

FIG. 5 is an isometric view of the upper section of the one or more fluid tank assemblies showing piping for the three storage tanks, according to one example embodiment.

FIG. 6 is a cross section view of a lower section of the storage pile assembly showing the pile, one or more fluid tank assemblies and the bottom structure, according to one example embodiment.

FIG. 7 is a cross section view of the one or more fluid tank assemblies showing various embodiments of heating systems for the storage tanks, according to one example embodiment.

FIGS. 8A, 8B, 8C and 8D show a top view cross-section of various shapes and configurations of storage assembly inside the pile, according to various example embodiments.

FIG. 9 is a cross section view of the storage pile assembly showing the one or more fluid tank assemblies being removed from the pile for maintenance, according to one example embodiment.

FIG. 10 is a cross section view of storage pile assembly with insulation on top of the one or more fluid tank assemblies, according to one example embodiment.

FIG. 11 is a cross section view of storage pile assembly showing insulation around each pipe, according to one example embodiment.

FIG. 12 is an isometric view of a top section of the pile showing a structural support plate, according to one example embodiment.

### DETAILED DESCRIPTION OF THE DRAWINGS

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

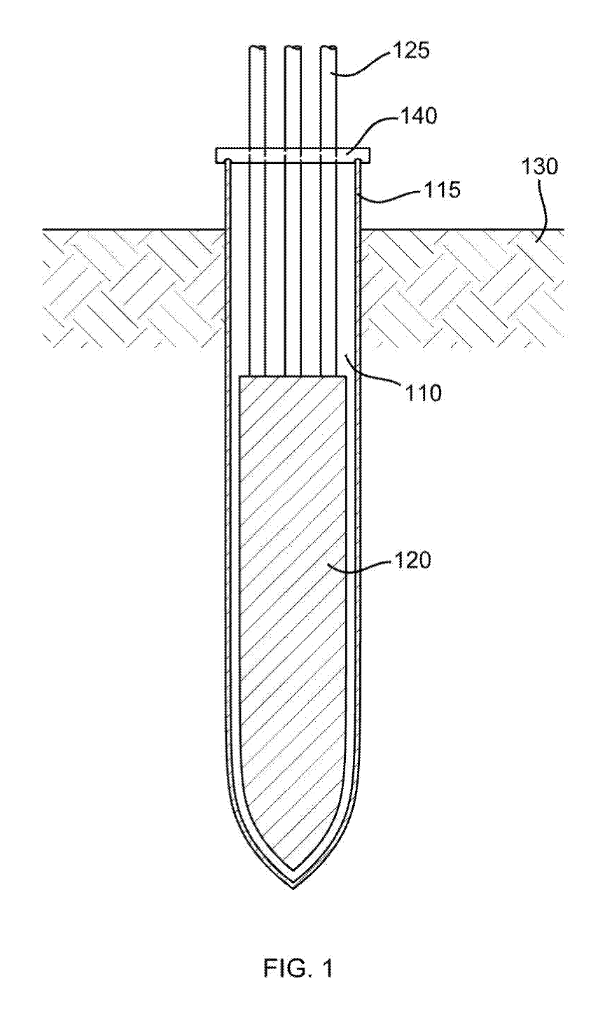

FIG. 1 is a cross section view of storage pile assembly 110; comprising a pile 115, one or more fluid tank assemblies 120, and piping 125. The pile 115 is driven into the ground 130 deep enough to allow the one or more fluid tank assemblies 120 to be completely below the ground level. By placing the one or more fluid tank assemblies 120 underground, the tank is protected from extremes in temperatures as the ground assists in insulating the tank. The pile 115 also protects the one or more fluid tank assemblies from potential damage from shifts in the ground, roots from trees, or other underground disruptions that may have an impact on the integrity of the one or more fluid tank assemblies 120. Structural support plate 140 supports the building or structure that rests on the pile 115, the pile 115 serving with other piles as a foundation for the building.

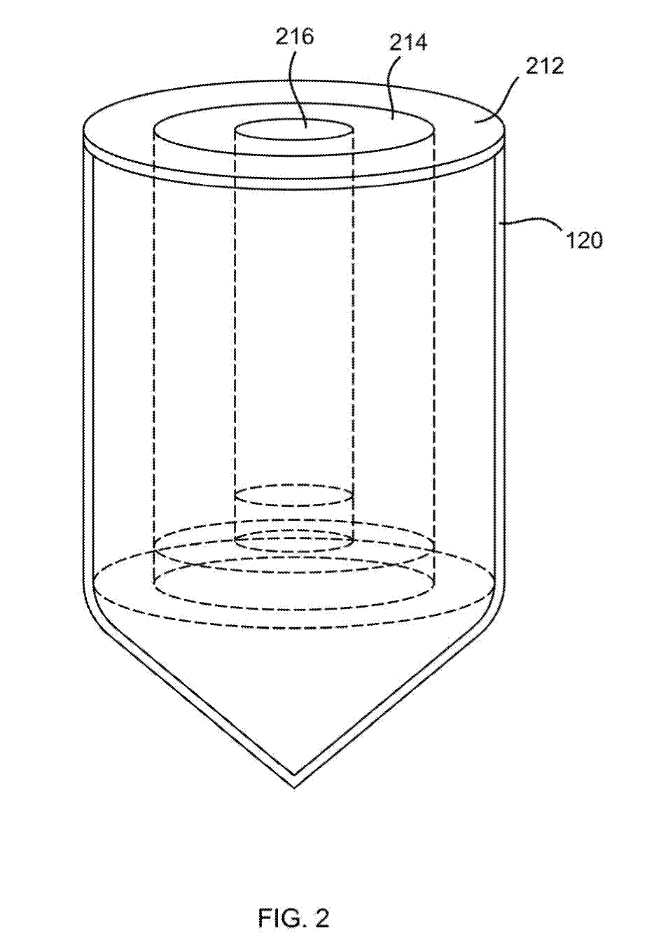

FIG. 2 is an isometric view of one embodiment of the one or more fluid tank assemblies 120 showing three cylindrical tanks within the one or more fluid tank assemblies 120. First tank 212 is shown with second tank 214 inside of the first tank 212, and third tank 216 is inside of the second tank 214. The fluid with the highest temperature is placed inside of the third tank 216. The second highest temperature fluid is placed in the second tank 214, and the lowest temperature fluid is in the first tank 212. As heat transfers from the hottest fluid in the third tank 216 to the second tank 214, heat loss is minimized because the temperature of the fluid in the second tank 214 is at an elevated temperature. Also, the heat transfer from the hottest fluid in the third tank 216 assists in maintaining the level of heat in the fluid of the second tank 214. Likewise, the heat from the second tank 214 assists in maintaining the level of heat in the fluid in the first tank 212.

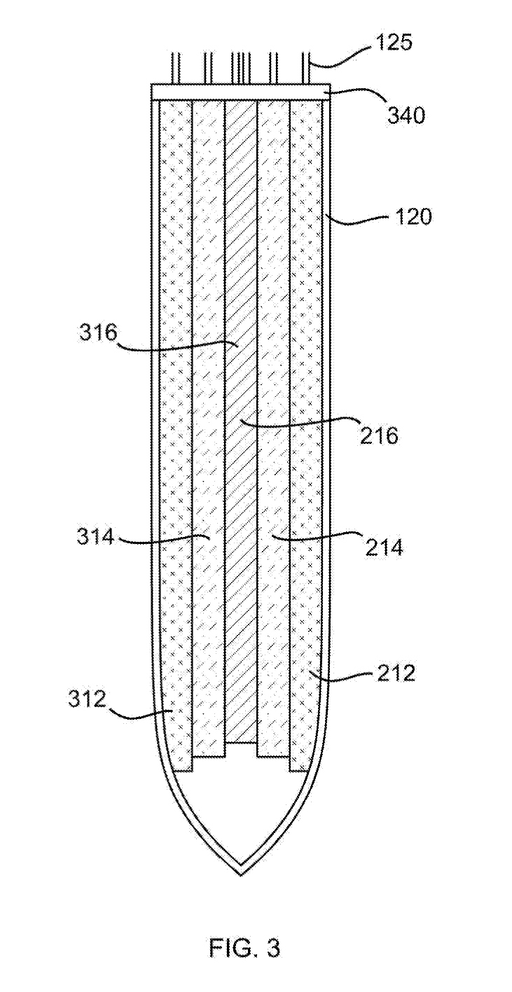

FIG. 3 is a cross section view of the one or more fluid tank assemblies 120 showing fluids of varying temperatures inside each of three storage tanks. Piping 125 circulates the heated fluid into and out of the tanks within the one or more fluid tank assemblies 120. First tank 212 has the lowest temperature fluid 312. Second tank 214 has a higher temperature fluid 314 than the fluid in the first tank 212. Third tank 216 has the fluid with the highest temperature 316, which is a higher temperature than second tank 214. Each of the fluids shown in the various tanks of the one or more fluid tank assemblies 120 are either a liquid or a gas. The fluids are either under pressure or not pressurized, depending on the requirements of the specific application they serve. Top cap 340 seals the top of the one or more fluid tank assemblies creating an enclosure that can be pressurized as required.

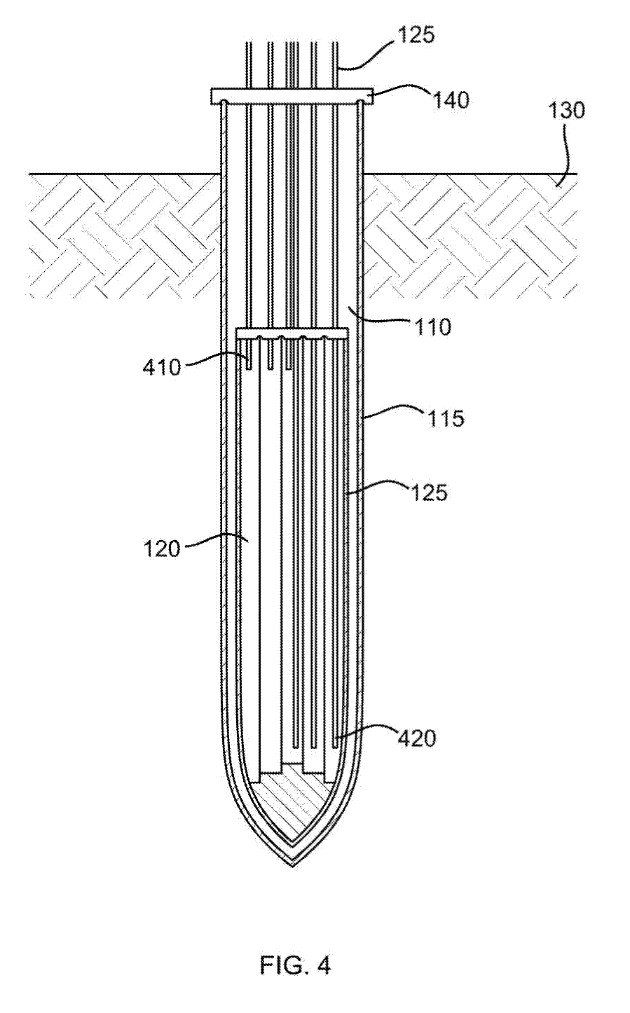

FIG. 4 is a cross section view of the storage pile assembly 110 showing piping 125 entering the assembly thru the structural support plate 140 and extending into the one or more fluid tank assemblies 120. Supply piping 420 extends to the bottom of the tank, and return piping 410 at the top of each tank extends from the tank back to the systems being served. The fluid flows into the one or more fluid tank assemblies via the supply piping 420, then out of the one or more fluid tank assemblies via the return piping 410. The entire one or more fluid tank assemblies is below ground 130 and inside the pile 115. In an embodiment, one or more fluid tank assemblies 120 may have insulation 125 on a surface of the storage tank.

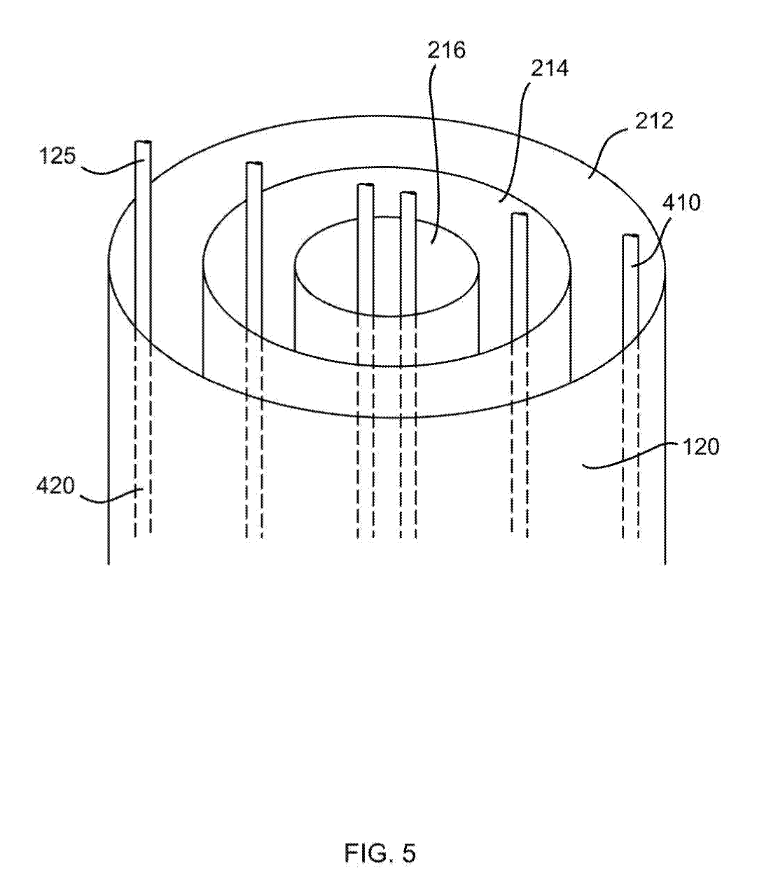

FIG. 5 is an isometric view of the upper section of the one or more fluid tank assemblies 120 showing piping 125 serving each of the three storage tanks. First tank 212 is shown with two pipes, supply piping 420 and return piping 410. Likewise second tank 214 and third tank 216 each have two pipes for supply and return of the fluid.

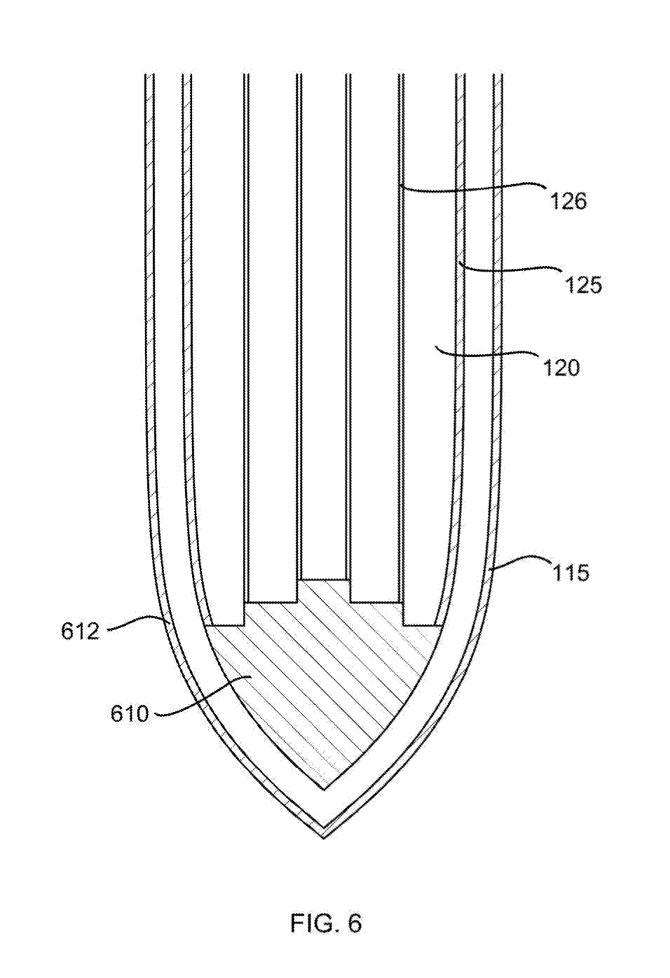

FIG. 6 is a cross section view of a lower section of the storage pile assembly showing the pile 115, one or more fluid tank assemblies 120 and the bottom structure 610 forming a seal at the bottom of the one or more fluid tank assemblies enclosing the bottom of the tanks and providing structural support for the tanks. In an embodiment, the outer surface of the storage assembly may have insulation 125. In another embodiment, each of the other storage tanks may have insulation 126 on a surface between the enclosures. In another embodiment, the pile may be insulated 612.

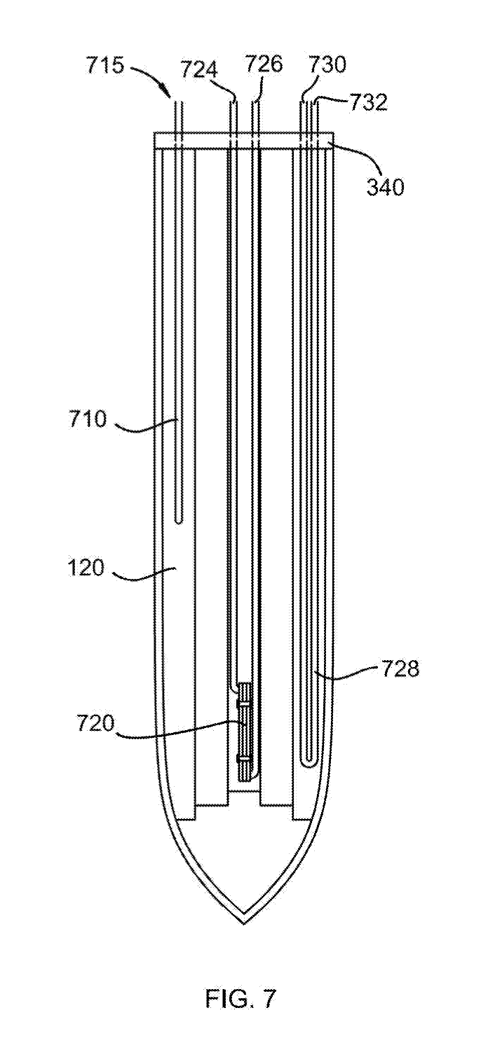

FIG. 7 is a cross section view of the one or more fluid tank assemblies 120 showing various embodiments of heating systems for the storage tanks. Electrical heating element 710 is placed either within the storage tank or on an exterior surface of the tank. Electrical wiring 715 is extended to the power and control circuit. In another embodiment, input piping 724 feeds heating fluid thru heat exchanger 720 heating the fluid, then returning via return piping 726. In an embodiment, heated fluid enters supply piping 730 into the tank, interfacing 728 the fluid within the tank, then exiting the tank via return piping 732. Top cap 340 seals the top of the one or more fluid tank assemblies creating an enclosure that can be pressurized as required.

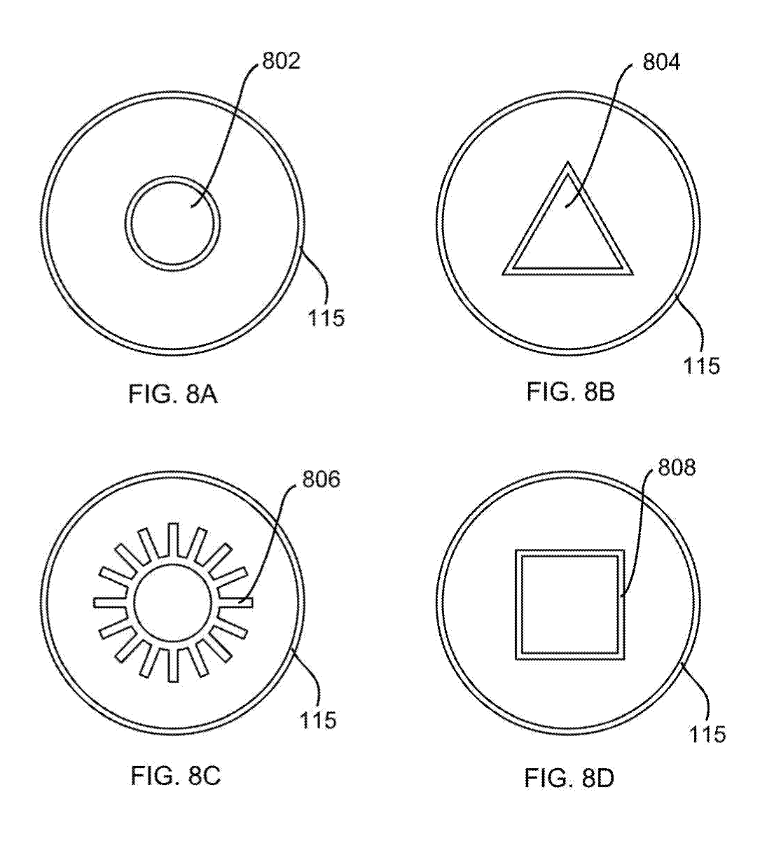

FIGS. 8A, 8B, 8C and 8D show a top view cross-section of various configurations of storage assembly inside the pile. The shape and configuration of the tank either enhances heat transfer between the storage tanks, or reduces the heat transfer as required for the specific applications. FIG. 8A shows a cylindrical storage assembly 802 inside the pile 115. FIG. 8B shows a triangular storage assembly 804 inside the pile 115. FIG. 8C shows a heat sink shaped storage assembly 806 inside the pile 115. FIG. 8D shows a square shaped storage assembly 808 inside the pile 115.

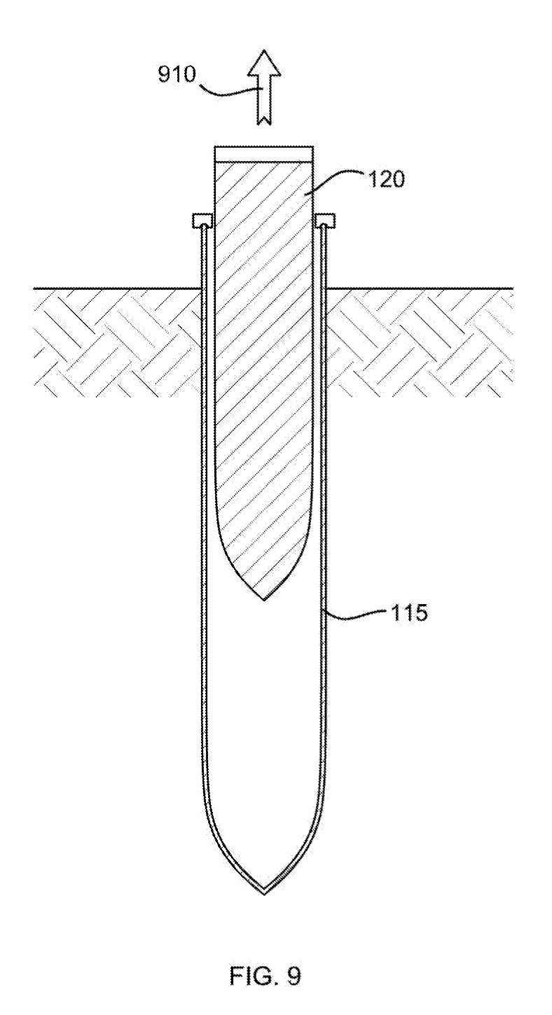

FIG. 9 is a cross section view of the storage pile assembly showing the one or more fluid tank assemblies 120 being removed 910 from the pile 115 for maintenance.

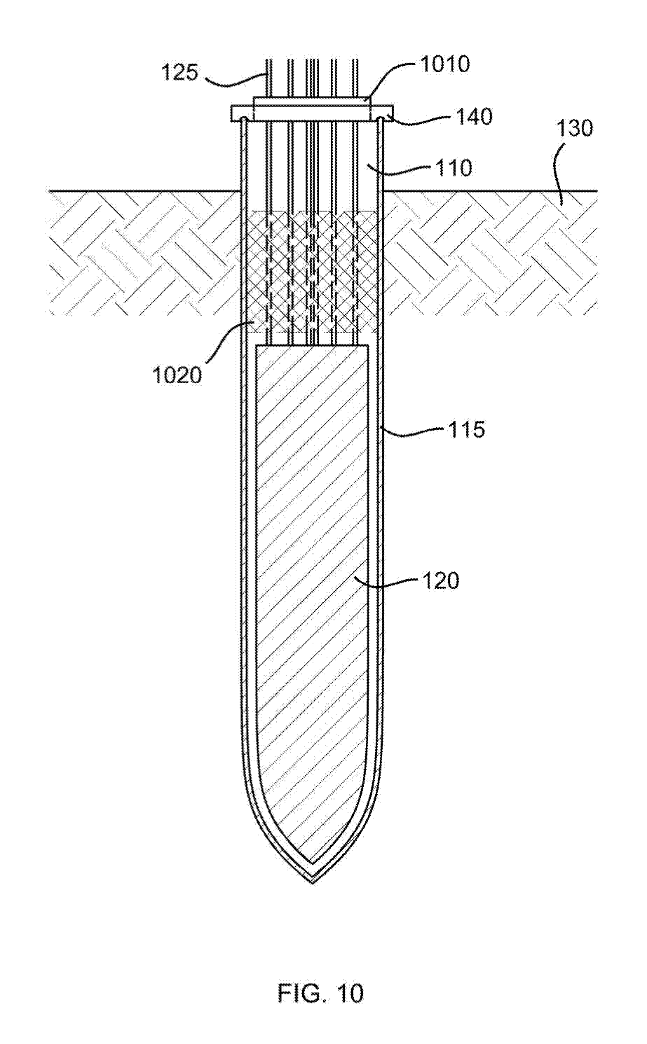

FIG. 10 is a cross section view of storage pile assembly 110; comprising a pile 115, one or more fluid tank assemblies 120, and piping 125. The pile 115 is driven into the ground 130 deep enough to allow the one or more fluid tank assemblies 120 to be completely below the ground level. Insulation 1020 is placed on top of the one or more fluid tank assemblies 120, inside of the pile 115, further insulating the one or more fluid tank assemblies 120. Seal cap 1010 is inserted inside the structural support plate 140, encapsulating and sealing the pipe penetrations, providing an environmental seal and barrier protecting the inside of the pile from the elements.

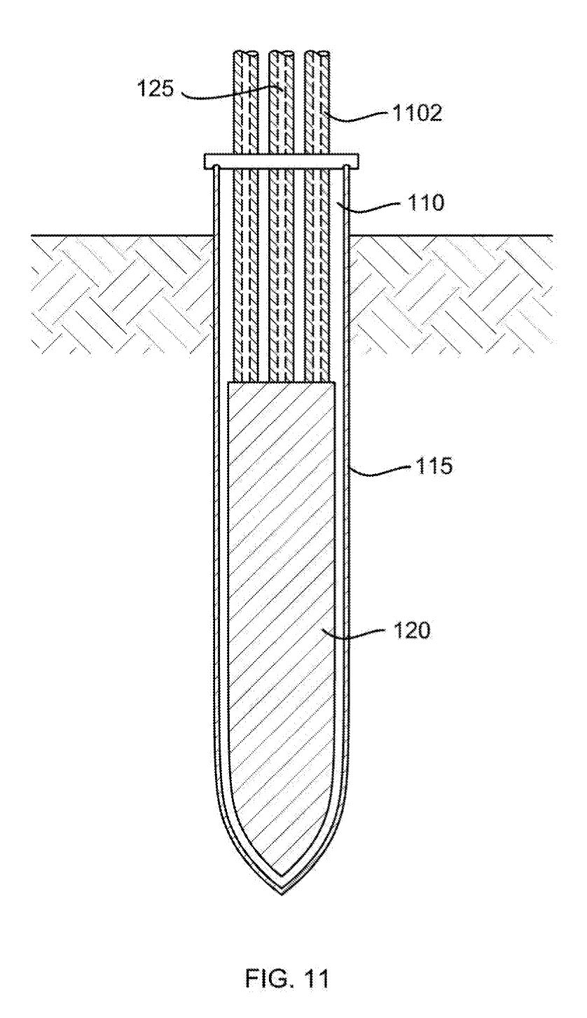

FIG. 11 is a cross section view of storage pile assembly 110; comprising a pile 115, one or more fluid tank assemblies 120, and piping 125. Insulation 1102 is placed around each pipe providing protection from heat loss thru the piping during operation of the system.

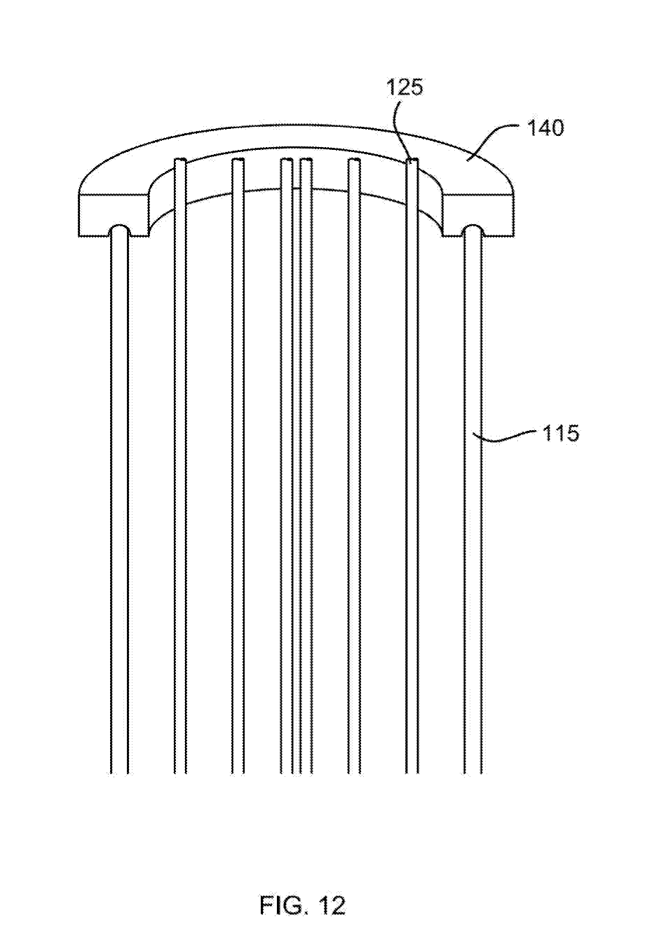

FIG. 12 is an isometric view of a top section of the pile 115. Structural support plate 140 is shown, having an opening in the center allowing piping 125 to be extended from the one or more fluid tank assemblies below up thru the support plate 140 and extended to the systems being served.

1. A storage pile assembly, comprising:
an at least partially hollow cylindrical foundation pile comprising a longitudinal central axis;
one or more fluid tank assemblies concentric with the central axis disposed inside the foundation pile;
piping for supply and return of fluids to the one or more tank assemblies; and
wherein the foundation pile is driven into the ground and the tank assemblies reside within a section of the foundation pile that is at least two to twenty meters below ground level.

2. The storage pile assembly of claim 1, wherein the one or more fluid tank assemblies further comprise;
a first tank;
a second tank within the first tank; wherein a first space between the first tank and the second tank creates a first capacity for storage of a first volume of fluid;
a third tank within the second tank; wherein a second space between the second tank and the third tank creates a second capacity for storage of a second volume of fluid; and
wherein the third tank creates a third capacity inside the third tank for storage of a third volume of fluid.

3. The storage pile assembly of claim 1, wherein the fluid stored inside the one or more fluid tank assemblies is either a liquid or a gas.

4. The storage pile assembly of claim 1, wherein the fluid stored inside the one or more fluid tank assemblies is either pressurized or non-pressurized.

5. The storage pile assembly of claim 1, wherein each of the one or more volumes of fluid stored inside the one or more fluid tank assemblies of the one or more fluid tank assemblies are of different temperatures.

6. The storage pile assembly of claim 2, wherein the temperature of the first volume of fluid is at a lower temperature than the second volume of fluid; and
wherein the second volume of fluid is at a lower temperature than the third volume of fluid.

7. The storage pile assembly of claim 1, wherein one or more surfaces of the one or more fluid tank assemblies are thermally insulated.

8. The storage pile assembly of claim 1, wherein each individual tank of the one or more fluid tank assemblies further comprise an inlet pipe for supplying fluid, and an outlet pipe for fluid flowing out.

9. The storage pile assembly of claim 8, wherein the inlet pipe extends to a location near a bottom of the individual tank, and the outlet pipe is at a location near a top of the individual tank.

10. The storage pile assembly of claim 1, further comprising heating elements within each of the one or more fluid tank assemblies for heating fluid contained within each of the one or more fluid tank assemblies.

11. The storage pile assembly of claim 10, wherein the heating elements comprise components from the group of: electric heat tape, electric heat trace, heat exchangers, heating pipes, and heat exchange mechanisms.

12. The storage pile assembly of claim 1, further comprising sensors from the group of: temperature sensors, pressure sensors, and flow sensors for monitoring conditions within each section of the one or more fluid tank assemblies.

13. The storage pile assembly of claim 1, wherein a shape of each storage section is configured to minimize heat transfer between the one or more fluid tank assemblies.

14. The storage pile assembly of claim 1, wherein a shape of each storage section is configured to maximize heat transfer between the one or more fluid tank assemblies.

15. The storage pile assembly of claim 1, wherein each of the one or more fluid tank assemblies is a storage tank.

16. The storage pile assembly of claim 1, wherein the one or more fluid tank assemblies is removeable from the pile for maintenance or replacement.

17. The storage pile assembly of claim 1, further comprising insulation inside a top section of the pile above the one or more fluid tank assemblies.

18. The storage pile assembly of claim 1, wherein a top of the pile is capped, sealing an interior of the pile and the one or more fluid tank assemblies from outdoor elements from the group of: water, dirt, insects and all other elements that may degrade or damage the one or more fluid tank assemblies.

19. The storage pile assembly of claim 8, wherein the inlet pipe and the outlet pipe are insulated.

20. The storage pile assembly of claim 1, further comprising a structural support plate at the top of the pile for support of a building or structure; and wherein the support plate comprises an opening for inlet and outlet pipes to extend from the interior of the pile to systems outside of the pile.
